(19) United States
(12) Patent Application Publication
(10) Pub. No.: US 2025/0239824 A1
(43) Pub. Date: Jul. 24, 2025

(54) RECEPTACLE WITH USB WALL-PLATE ACCESSORY SYSTEM

(71) Applicant: Hubbell Incorporated, Shelton, CT (US)

(72) Inventor: John Brower, Fairfield, CT (US)

(21) Appl. No.: 19/027,241

(22) Filed: Jan. 17, 2025

Related U.S. Application Data
(60) Provisional application No. 63/622,831, filed on Jan. 19, 2024.

(51) Int. Cl. H01R 27/02; H01R 13/62

(52) U.S. Cl. CPC H01R 27/02; H01R 13/6205

(57) ABSTRACT

An electrical receptacle assembly including an electrical receptacle having a front surface and a first set of contacts on the front surface and a wall-plate. The wall-plate includes an outer surface, an inner surface opposite the outer surface, and a second set of contacts positioned on the inner surface. The second set of contacts releasably and electrically connect to the first set of contacts. The wall-plate also includes a printed circuit board electrically connected to the second set of contacts and a plurality of electrical connectors configured to electrically connect to a plurality of accessory devices.

### RELATED APPLICATIONS

This application claims the benefit of U.S. Provisional Patent Application No. 63/622,831, filed Jan. 19, 2024, the entire content of which is hereby incorporated by reference.

### FIELD

The present disclosure relates generally to electrical receptacles.

### SUMMARY

Electrical devices, specifically electrical receptacles capable of receiving electrical plugs, generally include two or three sets of blade apertures, with each set arranged to receive an electrical plug. The electrical receptacle also generally includes one to three ports arranged to receive a corded connection to an external device. The electrical receptacle may be sold as a single unit or a multi-pack in home improvement stores and is then wired into electrical infrastructure by either a professional electrician or by the homeowner if the homeowner is comfortable with electrical wiring. For the average homeowner, the number of ports of the electrical receptacle may limit the available connections to various accessories that can connect to the electrical receptacle. For example, different outlet types are increasingly being used in homes, including various USB outlets.

One aspect of the present disclosure provides an electrical receptacle assembly including an electrical receptacle having a front surface and a first set of contacts on the front surface and a wall-plate. The wall-plate includes an outer surface, an inner surface opposite the outer surface, and a second set of contacts positioned on the inner surface. The second set of contacts releasably and electrically connect to the first set of contacts. The wall-plate also includes a printed circuit board electrically connected to the second set of contacts and a plurality of electrical connectors configured to electrically connect to a plurality of accessory devices.

Another aspect of the present disclosure provides an electrical receptacle assembly including an electrical receptacle having a front surface and a first set of contacts on the front surface and a wall-plate. The wall-plate includes an outer surface, an inner surface opposite the outer surface, and a second set of contacts positioned on the inner surface. The second set of contacts releasably and electrically connect to the first set of contacts. The wall-plate also includes a printed circuit board electrically connected to the second set of contacts and a plurality of electrical connectors configured to transfer power from the electrical receptacle. The electrical receptacle assembly also includes a plurality of accessory devices configured to electrically connect to the plurality of the electrical connectors.

Another aspect of the present disclosure provides a method of providing an electrical receptacle assembly. The method includes providing an electrical receptacle having a front surface and a first set of contacts on the front surface and providing a wall-plate including an outer surface and an inner surface opposite the outer surface. The inner surface includes a second set of contacts releasably and electrically connected to the first set of contacts, and a plurality of electrical connectors. The method also includes receiving, via the plurality of electrical connectors, a plurality of accessory devices.

Other aspects of the disclosure will become apparent by consideration of the detailed description and accompanying drawings.

### BRIEF DESCRIPTION OF THE DRAWINGS

FIG. 1 illustrates a front view of an electrical receptacle assembly, according to some embodiments.

FIG. 2 illustrates an electrical receptacle and a wall-plate of an electrical receptacle assembly, according to some embodiments.

FIG. 3 illustrates an accessory device of an electrical receptacle assembly, according to some embodiments.

FIG. 4 illustrates a block diagram of a control system of an electrical receptacle assembly, according to some embodiments.

FIG. 5 illustrates a front view of an electrical receptacle assembly, according to some embodiments.

FIG. 6 illustrates a front view of an electrical receptacle assembly connected to an external device, according to some embodiments.

FIG. 7 illustrates a front view of an electrical receptacle assembly connected to an external device, according to some embodiments.

FIG. 8 is a flowchart illustrating a method of providing an electrical receptacle assembly, according to some embodiments.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

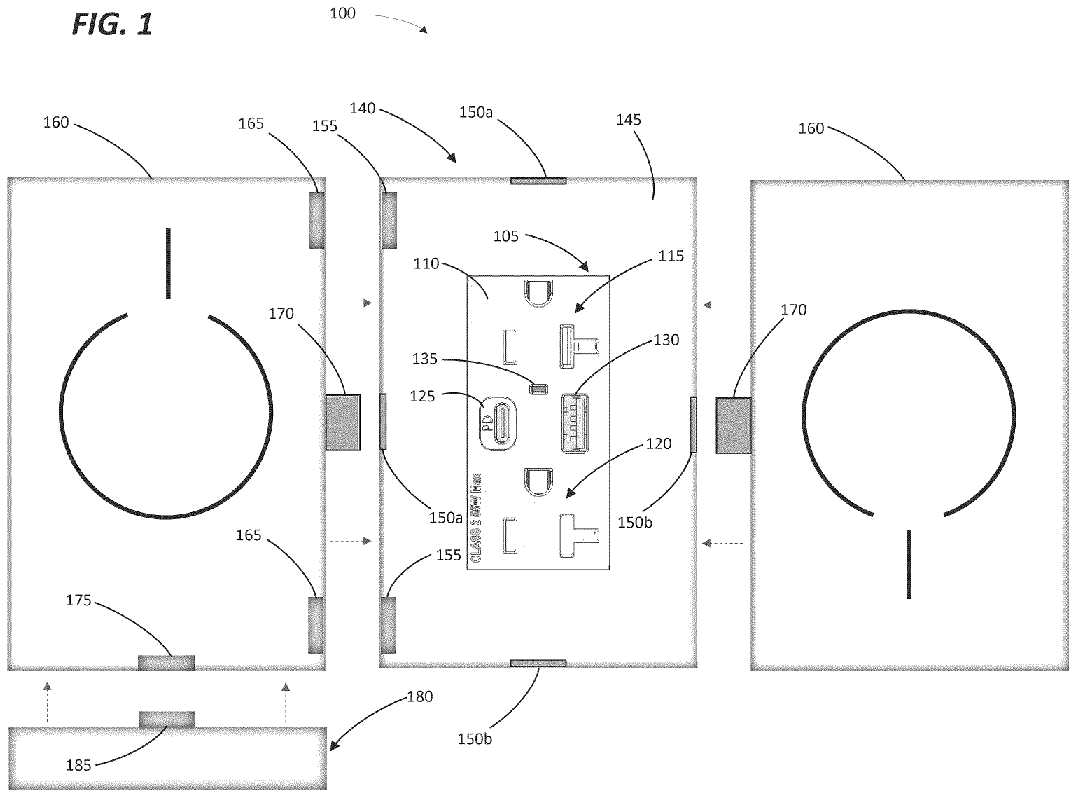

FIG. 1 illustrates a front view of an electrical receptacle assembly 100, according to some embodiments. The electrical receptacle assembly 100 includes an electrical receptacle 105 (e.g., an electrical outlet) having a front surface 110. In some embodiments, the front surface 110 may be a faceplate or a sub-faceplate of the electrical receptacle 105. In some embodiments, the electrical receptacle 105 further includes a first receptacle opening 115, a second receptacle opening 120, a power delivery port 125, an external device port 130, and an indicator 135 provided on the front surface 110. In some embodiments, the first receptacle opening 115 and the second receptacle opening 120 are each in a standard three-prong configuration having hot, neutral, and ground openings. Other outlet opening configurations can be used including any residential, commercial, or industrial standard outlets. Additionally, although described herein as having the first receptacle opening 115 and the second receptacle opening 120, the electrical receptacle 105 may have a greater number or a fewer number of receptacle openings.

In some embodiments, the power delivery port 125 is configured to receive a wired connection and deliver power via the wired connection. For example, the power delivery port 125 electrically connects to an external device via the wired connection and delivers power to the external device. In some embodiments, the power delivery port 125 is a USB-C power delivery port. Similarly, the external device port 130 is configured to receive a wired connection. In some embodiments, the external device port 130 is a USB-A port. The external device port 130 electrically connects the electrical receptacle 105 to an external device via the wired connection. In other embodiments, the external device port 130 electrically connects the electrical receptacle 105 directly to the external device, such as, for example, a flash drive. In some embodiments, the indicator 135 is an indicator light, such as, for example, a light emitting diode (LED). The indicator 135 may convey an indication of a status of a load connected to the first receptacle opening 115 and/or the second receptacle opening 120. In other embodiments, the indicator 135 may convey an indication of a status of the front surface 110. For example, the indication of the status of the front surface 110 conveys to a user that the electrical receptacle 105 is connected to another component of the electrical receptacle assembly 100 via the front surface 110.

As illustrated in the embodiment of FIG. 1, the electrical receptacle assembly 100 also includes a wall-plate 140 having an outer surface 145. The wall-plate 140 is electrically connected to the electrical receptacle 105. In some embodiments, the wall-plate 140 includes a plurality of electrical connectors 150 and a first set of magnets 155. Each electrical connector of the plurality of electrical connectors 150 is configured to electrically connect to a plurality of accessory devices 160. In some embodiments, the plurality of electrical connectors 150 is configured to transfer power from the electrical receptacle 105 to the plurality of accessory devices 160. For example, the plurality of electrical connectors 150 includes a first electrical connector 150a and a second electrical connector 150b. Although illustrated as the plurality of electrical connectors 150 including four electrical connectors, it should be understood that the plurality of electrical connectors 150 may only include the first electrical connector 150a and the second electrical connector 150b. The four electrical connectors shown in FIG. 1 are purely for illustrative purposes to portray example positions of the plurality of electrical connectors 150. For example, the first electrical connector 150a may be positioned on a first side of the wall-plate 140 and the second electrical connector 150b may be positioned on a second side of the wall-plate 140. In some embodiments, the second side of the wall-plate 140 is opposite the first side of the wall-plate 140. In another example, the first electrical connector 150a may be positioned on a third side of the wall-plate 140 and the second electrical connector 150b may be positioned on a fourth side of the wall-plate 140. In some embodiments, the plurality of electrical connectors 150 includes four electrical connectors with each electrical connector of the four connectors on a respective side of the wall-plate 140. In other embodiments, the plurality of electrical connectors 150 includes any number of electrical connectors. In some embodiments, each electrical connector of the plurality of electrical connectors 150 is a USB-C connector (e.g., a USB-C port). In some embodiments, each electrical connector of the plurality of electrical connectors 150 supports a weight of each accessory device of the plurality of accessory devices 160.

The first set of magnets 155 is configured to magnetically couple to the plurality of accessory devices 160. In some embodiments, each accessory device of the plurality of accessory devices 160 includes a second set of magnets 165, a connector plug 170, and a retention connector 175. Each electrical connector of the plurality of electrical connectors 150 is configured to receive the connector plug 170. As such, in some embodiments, the connector plug 170 is a USB-C plug. Accordingly, each accessory device of the plurality of accessory devices 160 electrically connects to the wall-plate 140 in response to an electrical connector of the plurality of electrical connectors 150 receiving the connector plug 170. When each accessory device of the plurality of accessory devices 160 electrically connects to the wall-plate 140, the second set of magnets 165 magnetically couples to the first set of magnets 155. The magnetic coupling of the second set of magnets 165 to the first set of magnets 155 may prevent rotational torque of the plurality of accessory devices 160 relative to the wall-plate 140. The retention connector 175 is configured to receive an additional accessory device 180. The additional accessory device 180 includes a retention plug 185. In some embodiments, the retention connector 175 and the retention plug 185 are formed to snap-fit together such that each accessory device of the plurality of accessory devices 160 is configured to receive the additional accessory device 180.

Additionally, in some embodiments, the plurality of accessory devices 160 includes a wireless charger. For example, the wireless charger may be an inductive charger configured to induce a charging current in a connected external device. In some embodiments, the wall-plate 140 may receive a first accessory device of the plurality of accessory devices 160 via the first electrical connector 150a. In other embodiments, the wall-plate 140 may receive a second accessory device of the plurality of accessory devices 160 via the second electrical connector 150b. In some embodiments, the wall-plate 140 may receive the first accessory device and the second accessory device of the plurality of accessory devices 160 via the first electrical connector 150a and the second electrical connector 150b, respectively. In some embodiments, the additional accessory device 180 may be a shelf configured to support a weight of the connected external device.

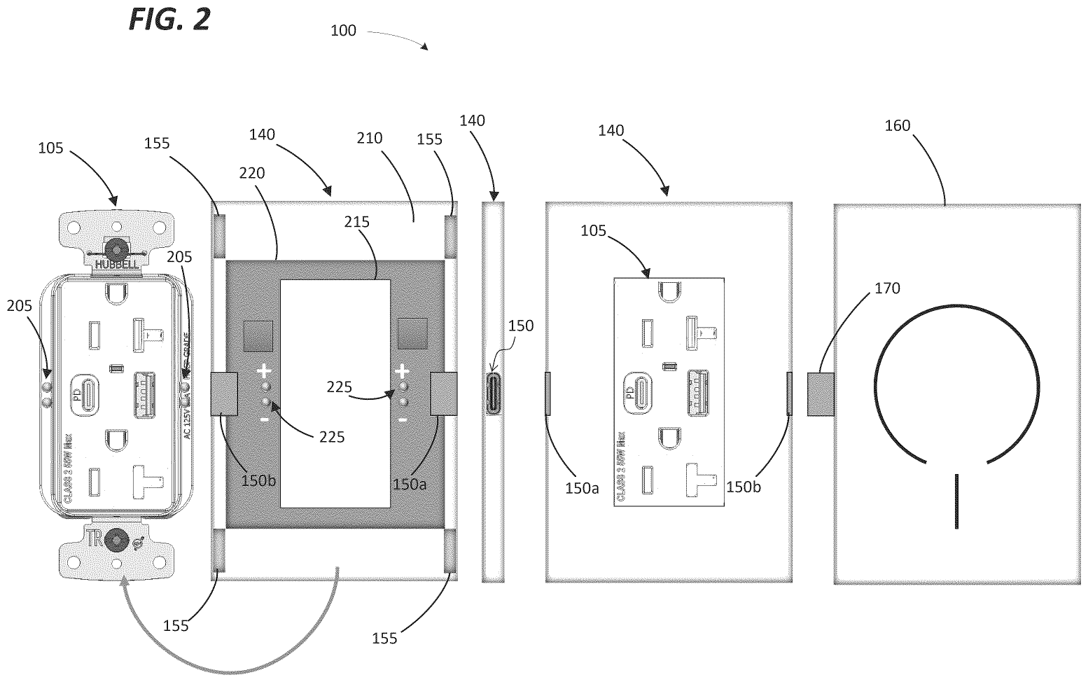

FIG. 2 illustrates the electrical receptacle 105 and the wall-plate 140 of the electrical receptacle assembly 100, according to some embodiments. It should be understood that FIG. 2 illustrates a plurality of views of the electrical receptacle 105 and the wall-plate 140 for ease of description. As illustrated in the embodiment of FIG. 2, the electrical receptacle 105 also includes a first set of contacts 205 provided on the front surface 110. The first set of contacts 205 may be spring contacts, pin contacts, or other suitable contacts. The first set of contacts 205 provide low voltage, AC, or DC power, and/or communication (Serial, UART, I2C, SPI) between the electrical receptacle 105 and the wall-plate 140. The first set of contacts 205 provide a low-voltage connection that is not dangerous to a user or requires a professional electrician for installation.

The wall-plate 140 includes an inner surface 210 opposite the outer surface 145 and a receptacle opening 215. For example, the wall-plate 140 defines the receptacle opening 215 that extends between the inner surface 210 and the outer surface 245. In some embodiments, the receptacle opening 215 is sized to receive the electrical receptacle 105. For example, the receptacle opening 215 may be sized to receive the front surface 110. In some embodiments, the wall-plate 140 also includes a printed circuit board 220 and a second set of contacts 225. The printed circuit board 220 is electrically connected to the second set of contacts 225. In some embodiments, the second set of contacts 225 is positioned on the inner surface 210. For example, the second set of contacts 225 is positioned to align, or otherwise electrically connect to, with the first set of contacts 205. As such, the second set of contacts 225 is configured to releasably and electrically connect to the first set of contacts. In response to the second set of contacts 225 electrically connecting to the first set of contacts 205, the electrical receptacle 105 is in electrical communication with the wall-plate 140. Accordingly, the electrical receptacle 105 supplies operational power to the components of the wall-plate 140, such as, for example, the printed circuit board 220 and the plurality of electrical connectors 150.

In some embodiments, the printed circuit board 220 is configured to control an operation of the plurality of accessory devices 160. For example, the operation may be a charging operation of an external device via the plurality of accessory devices 160 in response to the plurality of electrical connectors 150 receiving the connector plug 170. Additionally, as illustrated in the embodiment of FIG. 2, the plurality of electrical connectors 150 is positioned on a side (e.g., the first side, the second side, the third side, the fourth side, etc.) of the wall-plate 140 between the outer surface 145 and the inner surface 210.

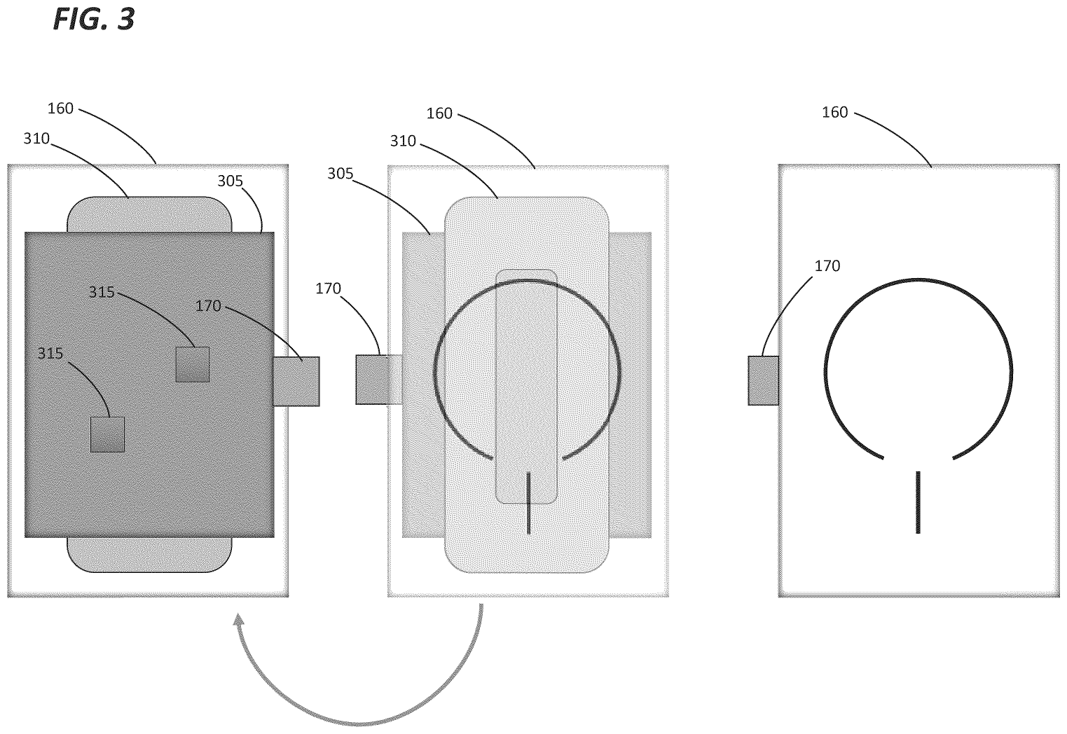

FIG. 3 illustrates an accessory device of the plurality of accessory devices 160 of the electrical receptacle assembly 100, according to some embodiments. In the illustrated embodiment of FIG. 3, the plurality of accessory devices 160 are shown as wireless chargers. However, in other embodiments, the plurality of accessory devices 160 may include other accessory devices configured to electronically communicate with an external device. In some embodiments, each accessory device of the plurality of accessory devices 160 includes a charging printed circuit board 305, a charging interface 310 in electronic communication with the charging printed circuit board 305, and a charging control electronics 315 included in the charging printed circuit board 305. For example, charging control electronics 315 may be an integrated circuit device, such as a Microchip microcontroller. However, in other embodiments, the charging control electronics 315 is implemented as another type of processor-based control device. The charging control electronics 315, which includes an electronic processor and a memory, may be configured to control various operations of the plurality of accessory devices 160. For example, in some embodiments, the charging control electronics 315 is configured to supply a charging current to the charging interface 310. In some embodiments, the charging interface 310 wirelessly supplies the charging current to an external device. In other embodiments, the charging control electronics 315 may receive a charging control command from the printed circuit board 220 of the wall-plate 140. In such embodiments, the charging control electronics 315 supplies the charging current to the charging interface 310 based on the charging control command.

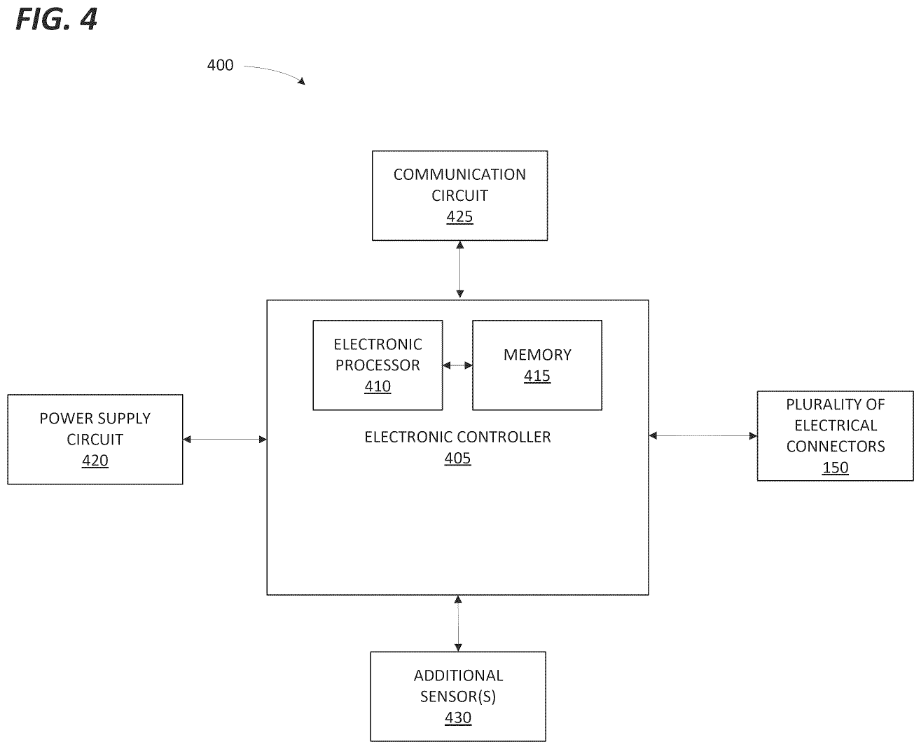

FIG. 4 illustrates a block diagram of a control system 400 of the electrical receptacle assembly 100, according to some embodiments. In some embodiments, some or all of the components of the control system 400 may be implemented in the wall-plate 140 (e.g, in the printed circuit board 220 connected to the plurality of electrical connectors 150). In other embodiments, some components of the control system 400 may be implemented external to the wall-plate 140, such as in the electrical receptacle 105 and the plurality of accessory devices 160. In some embodiments, the control system 400 includes an electronic controller 405. For example, the wall-plate 140 includes the electronic controller 405. The electronic controller 405 may be an integrated circuit device, such as a Microchip microcontroller. However, in other embodiments, the electronic controller 405 is implemented as another type of processor-based control device. The electronic controller 405, which includes an electronic processor 410 and a memory 415, may be configured to control various operations of the plurality of accessory devices 160. For example, in some embodiments, the electronic controller 405 is configured to control charging current supplied to the plurality of accessory devices 160 via the plurality of electrical connectors 150.

As illustrated in FIG. 4, the electronic controller 405 is electrically and/or communicatively connected to a variety of modules or components of the control system 400. For example, the electronic controller 405 is electrically connected to a power supply circuit 420, a communication circuit 425, additional sensor(s) 430, and the plurality of electrical connectors 150.

In some embodiments, the electronic controller 405 includes a plurality of electrical and electronic components that provide power, operational control, and protection to the components and modules within the electronic controller 405 and/or the electrical receptacle assembly 100. For example, the electronic controller 405 includes, among other things, the electronic processor 410 (for example, a microprocessor or another suitable programmable device) and the memory 415.

The memory 415 includes, for example, a program storage area and a data storage area. The program storage area and the data storage area can include combinations of different types of memory, such as read-only memory (ROM) and/or random-access memory (RAM). Various non-transitory computer readable media, for example, magnetic, optical, physical, or electronic memory may be used. The electronic processor 410 is communicatively coupled to the memory 415 and executes software instructions that are stored in the memory 415, or stored on another non-transitory computer readable medium such as another memory or a disc. Instructions may include instructions, which when executed by the electronic processor 410, cause the control system 400 to implement any of a variety of accessory device control actions as described herein. The software may include one or more applications, program data, filters, rules, one or more program modules, and other executable instructions.

In some embodiments, the power supply circuit 420 is configured to supply power to the components of the electrical receptacle assembly 100. For example, the electrical receptacle 105 includes the power supply circuit 420. The power supply circuit 420 supplies power to the electronic controller 405 and other components of the electrical receptacle assembly 100 in response to the wall-plate 140 electrically connecting to the electrical receptacle 105. In some embodiments, the communication circuit 425 supplies communication information and power between the wall-plate 140 and the electrical receptacle 105. For example, the communication circuit transmits the communication information between the second set of contacts 225 and the first set of contacts 205. In some embodiments, the additional sensor(s) 430 may include a current sensor, a temperature sensor, a voltage sensor, a humidity sensor, a capacitive sensor, a magnetic sensor, or any other suitable sensor for sensing characteristics of electrical receptacles.

In some embodiments, in response to the wall-plate 140 electrically connecting to the electrical receptacle 105 and receiving the plurality of accessory devices 160, the electronic controller 405 supplies the charging current command to the plurality of accessory devices 160 via the plurality of electrical connectors 150. For example, the plurality of accessory devices 160 may be baseline power profile (BPP) or extended power profile (EPP) wireless chargers. Accordingly, the electronic controller 405 supplies the charging current command according to BPP or EPP charging parameters. As such, a connected external device may receive up to 15 watts (W) of power from the plurality of accessory devices 160 based on the charging current command. Additionally, in response the wall-plate 140 receiving a first accessory device and a second accessory device of the plurality of accessory devices 160 via the first electrical connector 150a and the second electrical connector 150b, the electronic controller 405 supplies the charging current command to the first electrical connector 150a and the second electrical connector 150b such that the first accessory device and the second accessory device perform simultaneous charging. For example, the first accessory device and the second accessory device supply up to 15 W of power.

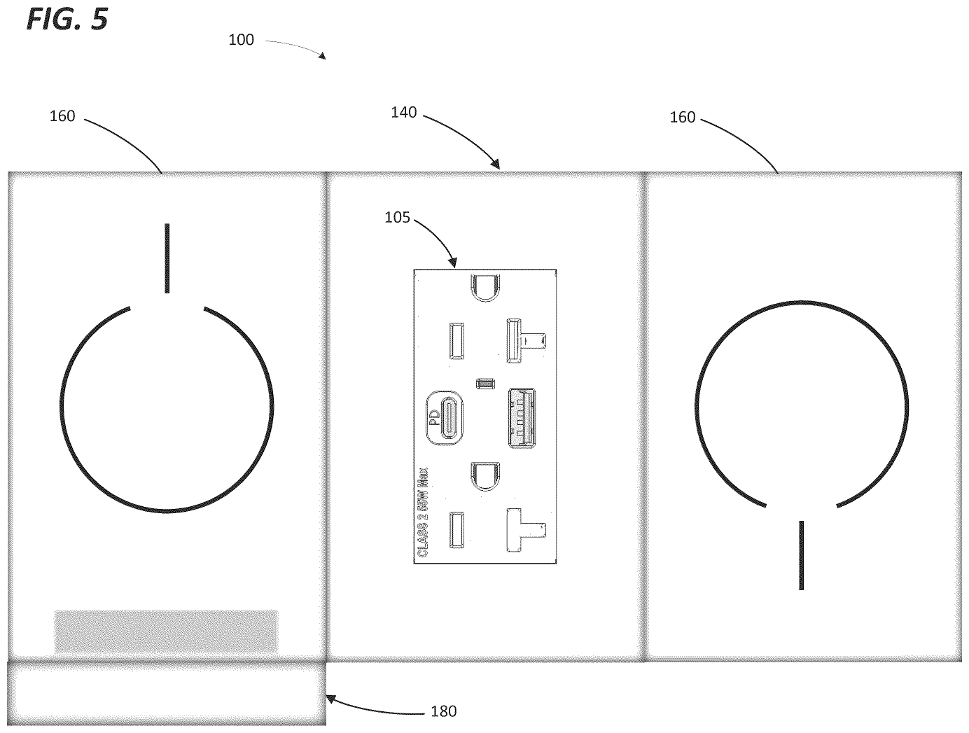

FIG. 5 illustrates a front view of the electrical receptacle assembly 100, according to some embodiments. As illustrated in FIG. 5, the wall-plate 140 is electrically connected to the electrical receptacle 105. For example, the second set of contacts 225 is electrically connected to the first set of contacts 205. Additionally, the plurality of accessory devices 160 is electrically connected to the wall-plate 140. For example, the first electrical connector 150a and the second electrical connector 150b respectively receive the connector plug 170 of separate accessory devices of the plurality of accessory devices 160. Furthermore, the plurality of accessory devices 160 receives the additional accessory device 180. For example, the retention connector 175 receives the retention plug 185.

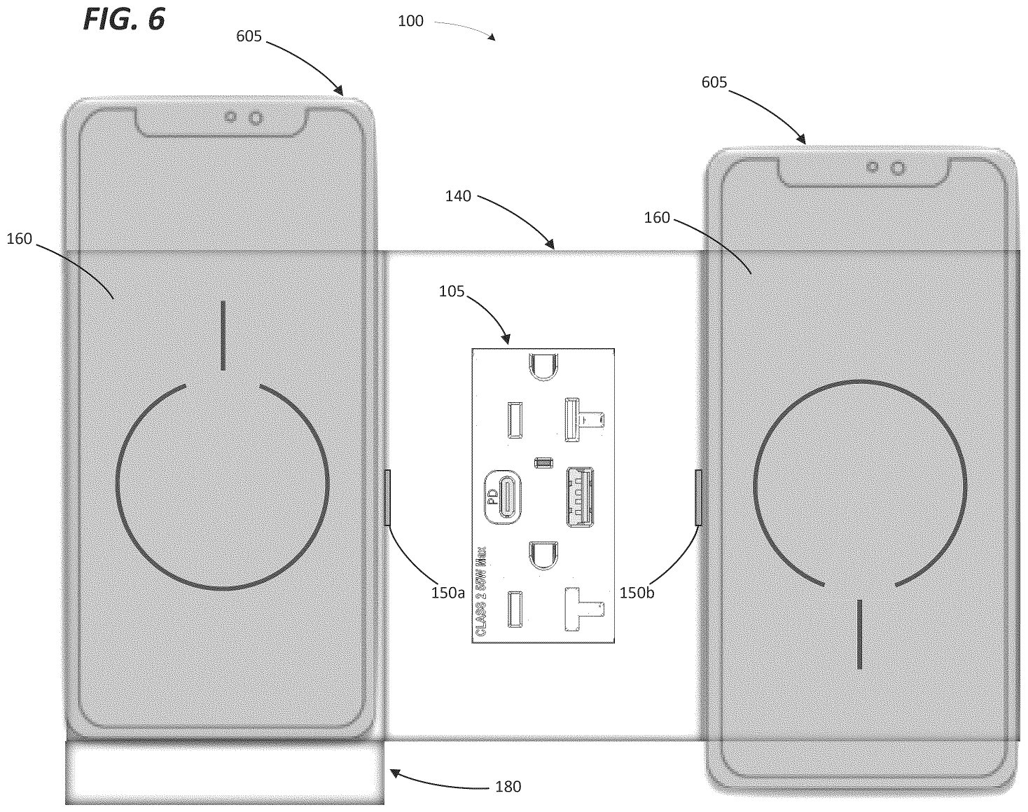

FIG. 6 illustrates a front view of the electrical receptacle assembly 100 connected to an external device 605, according to some embodiments. In some embodiments, the external device 605 is a mobile electronic device, such as, but not limited to a mobile phone. In other embodiments, the external device 605 may be wireless headphones, wireless earbuds, a smart watch, or any other suitable electronic device configured to wirelessly charge. In some embodiments, a user places the external device 605 on the plurality of accessory devices 160 and the plurality of accessory devices 160 supports the weight of the external device 605. In some embodiments, a use places the external device 605 on the plurality of accessory devices 160 connected to the additional accessory device 180. In such embodiments, the additional accessory device 180 supports the weight of the external device 605.

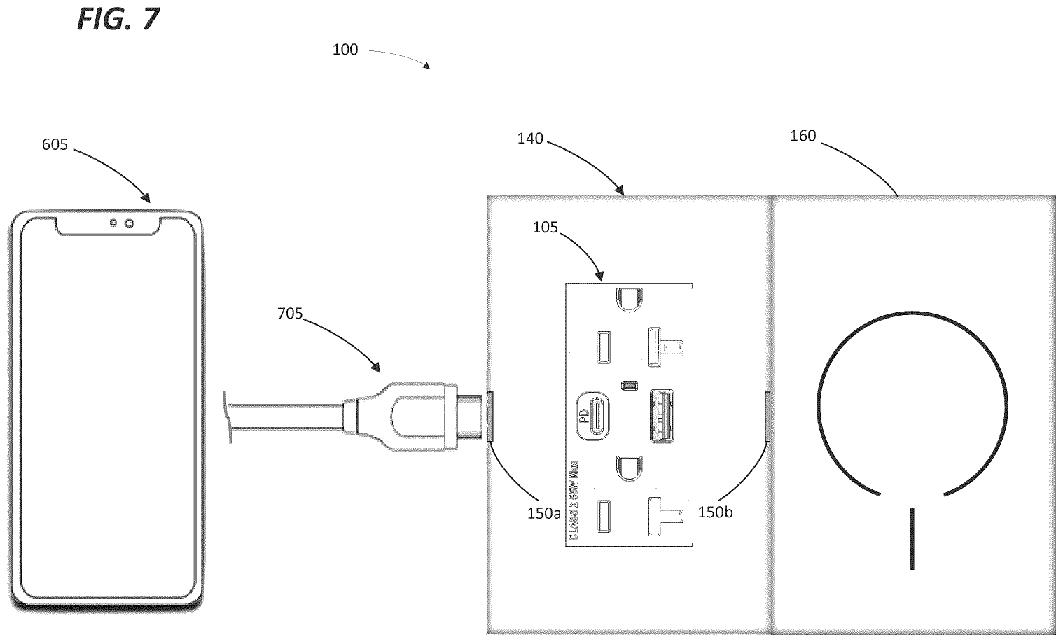

FIG. 7 illustrates a front view of the electrical receptacle assembly 100 connected to the external device 605, according to some embodiments. In some embodiments, the plurality of electrical connectors 150 is also configured to receive a wired connection 705. For example, the plurality of electrical connectors 150 is configured to electrically connect to the plurality of accessory devices 160 via the wired connection 705. In another example, the plurality of electrical connectors 150 is configured to electrically connect to the external device 605 via the wired connection 705. In some embodiments, the wired connection 705 is a USB-C charging cable. Additionally, in some embodiments, the first electrical connector 150a electrically connects to the external device 605 via the wired connection 705 and the second electrical connector 150b electrically connects to the plurality of accessory devices 160. In other embodiments, the second electrical connector 150b electrically connects to the external device 605 via the wired connection 705 and the first electrical connector 150a electrically connects to the plurality of accessory devices.

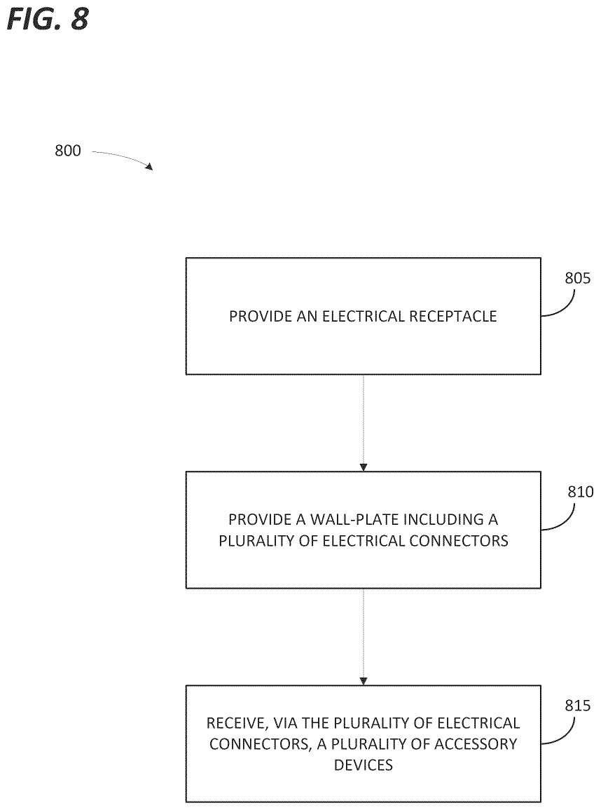

FIG. 8 is a flowchart of a method 800 of providing the electrical receptacle assembly 100, according to some embodiments. For example, the method 800 is implemented to electrically connect the components of the electrical receptacle assembly 100. It should be understood that the order of the steps disclosed in method 800 could vary. Although some steps are illustrated as occurring in serial order, in other embodiments, the steps disclosed may be performed in parallel order. Furthermore, additional steps may be added to the process and not all of the steps may be required.

At step 805, the method 800 includes providing the electrical receptacle 105. In some embodiments, the method 800 includes providing the electrical receptacle 105 having the front surface 110 and the first set of contacts 205 on the front surface 110. The method 800 then proceeds to step 810.

At step 810, the method 800 includes providing the wall-plate 140 including the plurality of electrical connectors 150. In some embodiments, the method 800 includes providing the wall-plate 140 including the outer surface 145 and the inner surface 210 opposite the outer surface 145. The inner surface 210 includes the second set of contacts 225 configured to releasably and electrically connect to the first set of contacts 205, and the plurality of electrical connectors 150. The method 800 then proceeds to step 815.

At step 815, the plurality of electrical connectors 150 receive the plurality of accessory devices 160. For example, the first electrical connector 150a and the second electrical connector 150b may each receive a respective one of the plurality of accessory devices 160. It should be understood that after the plurality of electrical connectors 150 receive the plurality of accessory devices 160 at step 815, the method 800 can be repeated by performing steps 805-815 in reverse order. For example, the method 800 returns to step 805 after performing steps 805-815 in reverse order.

Thus, the disclosure provides, among other things, a system and method for providing an electrical receptacle assembly. Various features and advantages of the various embodiments disclosed herein are set forth in the following claims. In the foregoing specification, specific examples, features, and aspects have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. An electrical receptacle assembly comprising:
an electrical receptacle having a front surface and a first set of contacts on the front surface; and
a wall-plate including
an outer surface,
an inner surface opposite the outer surface,
a second set of contacts positioned on the inner surface, the second set of contacts configured to releasably and electrically connect to the first set of contacts,
a printed circuit board electrically connected to the second set of contacts, and
a plurality of electrical connectors configured to electrically connect to a plurality of accessory devices.

2. The electrical receptacle assembly of claim 1, wherein a first electrical connector of the plurality of electrical connectors is positioned on a first side of the wall-plate, and
wherein a second electrical connector of the plurality of electrical connectors is positioned on a second side of the wall-plate, the second side opposite the first side.

3. The electrical receptacle assembly of claim 1, wherein a first electrical connector of the plurality of electrical connectors is positioned on a third side of the wall-plate, and
wherein a second electrical connector of the plurality of electrical connectors is positioned on a fourth side of the wall-plate, the fourth side opposite the third side.

4. The electrical receptacle assembly of claim 1, wherein the wall-plate includes a receptacle opening sized to receive the electrical receptacle.

5. The electrical receptacle assembly of claim 1, wherein the wall-plate includes a first set of magnets and each accessory device of the plurality of accessory devices includes a second set of magnets, and
wherein when each accessory device of the plurality of accessory devices electrically connects to the wall-plate, the second set of magnets magnetically couples to the first set of magnets.

6. The electrical receptacle assembly of claim 1, wherein each electrical connector of the plurality of electrical connectors is a USB-C connector.

7. The electrical receptacle assembly of claim 6, wherein each accessory device of the plurality of accessory devices includes a USB-C plug, and
wherein the USB-C connector is configured to receive the USB-C plug.

8. The electrical receptacle assembly of claim 1, wherein the plurality of accessory devices includes a wireless charger.

9. The electrical receptacle assembly of claim 1, wherein the plurality of electrical connectors are configured to electrically connect to the plurality of accessory devices via a wired connection.

10. The electrical receptacle assembly of claim 1, wherein the printed circuit board is configured to control an operation of the plurality of accessory devices.

11. An electrical receptacle assembly comprising:
an electrical receptacle having a front surface and a first set of contacts on the front surface;
a wall-plate including
an outer surface,
an inner surface opposite the outer surface,
a second set of contacts positioned on the inner surface, the second set of contacts configured to releasably and electrically connect to the first set of contacts,
a printed circuit board electrically connected to the second set of contacts,
a plurality of electrical connectors configured to transfer power from the electrical receptacle, and
a plurality of accessory devices configured to electrically connect to the plurality of electrical connectors.

12. The electrical receptacle assembly of claim 11, wherein a first electrical connector of the plurality of electrical connectors is positioned on a first side of the wall-plate, and
wherein a second electrical connector of the plurality of electrical connectors is positioned on a second side of the wall-plate, the second side opposite the first side.

13. The electrical receptacle assembly of claim 11, wherein a first electrical connector of the plurality of electrical connectors is positioned on a third side of the wall-plate, and
wherein a second electrical connector of the plurality of electrical connectors is positioned on a fourth side of the wall-plate, the fourth side opposite the third side.

14. The electrical receptacle assembly of claim 11, wherein the wall-plate includes a receptacle opening sized to receive the electrical receptacle.

15. The electrical receptacle assembly of claim 11, wherein the wall-plate includes a first set of magnets and each accessory device of the plurality of accessory devices includes a second set of magnets, and
wherein when each accessory device of the plurality of accessory devices electrically connects to the wall-plate, the second set of magnets magnetically couples to the first set of magnets.

16. The electrical receptacle assembly of claim 11, wherein each electrical connector of the plurality of electrical connectors is a USB-C connector.

17. The electrical receptacle assembly of claim 16, wherein each accessory device of the plurality of accessory devices includes a USB-C plug, and
wherein the USB-C connector is configured to receive the USB-C plug.

18. The electrical receptacle assembly of claim 11, wherein the plurality of accessory devices includes a wireless charger.

19. A method of providing an electrical receptacle assembly comprising:
providing an electrical receptacle having a front surface and a first set of contacts on the front surface;
providing a wall-plate including an outer surface and an inner surface opposite the outer surface, the inner surface includes a second set of contacts configured to releasably and electrically connect to the first set of contacts, and a plurality of electrical connectors; and
receiving, via the plurality of electrical connectors, a plurality of accessory devices.

20. The method of claim 19, wherein a first electrical connector of the plurality of electrical connectors is positioned on a first side of the wall-plate, and
wherein a second electrical connector of the plurality of electrical connectors is positioned on a second side of the wall-plate, the second side opposite the first side.
